(19) United States
(12) Patent Application Publication
(10) Pub. No.: US 2020/0209824 A1
(43) Pub. Date: Jul. 2, 2020

(54) NUMERICAL CONTROLLER

(71) Applicant: Fanuc Corporation, Yamanashi (JP)

(72) Inventor: Masataka Koike, Minamitsuru-gun (JP)

(73) Assignee: Fanuc Corporation, Yamanashi (JP)

(21) Appl. No.: 16/715,611

(22) Filed: Dec. 16, 2019

(30) Foreign Application Priority Data
Dec. 26, 2018 (JP) 2018-242960

(51) Int. Cl. G05B 19/19; G05B 19/414

(52) U.S. Cl. CPC G05B 19/19; G05B 2219/50218; G05B 19/414

(57) ABSTRACT

A numerical controller for performing axis synchronous control between a plurality of units in a master-slave mode performs speed-based synchronous control in a predetermined section and performs position-based synchronous control in another section.

### RELATED APPLICATIONS

The present application claims priority to Japanese Patent Application Number 2018-242960 filed Dec. 26, 2018, the disclosure of which is hereby incorporated by reference herein in its entirety.

### BACKGROUND OF THE INVENTION

### 1. Field of the Invention

The application relates to a numerical controller, and particularly relates to a numerical controller capable of accurately synchronizing a plurality of units.

### 2. Description of the Related Art

A system that performs machining by synchronizing positions of a plurality of industrial machines has been widely used. In the system in which units are synchronized, synchronization information (position command) is periodically transferred from a master unit to a slave unit, and operations are synchronized using the transferred synchronization information. However, in a system in which units are asynchronous, it is not easy to accurately synchronize operations using synchronization information.

A reason therefor will be described with reference to FIG. 1. FIG. 1 is a chart illustrating an example of a correspondence relationship between a transfer timing of synchronization information from a master unit (also simply referred to as a master) to a slave unit (also simply referred to as a slave) and positions of drive units in the master and the slave.

Normally, each of the master and the slave executes transmission and reception of synchronization information according to a predetermined clock interval. However, a communication timing of the master and the slave may vary due to a difference in the clock interval between the units and an influence of transfer jitter (communication timing fluctuation), which contributes to a decrease in synchronization accuracy between the master and the slave.

At time Tm1, the master generates a position command. The master determines the position of the drive unit thereof in accordance with the position command, and transmits the same position command to the slave as synchronization information S1. The synchronization information S1 is received by the slave at time Ts1 (>Tm1), and a position of the drive unit of the slave is synchronized with the master.

At time Tm2, the master generates a new position command. The master updates the position of the drive unit thereof in accordance with the new position command, and transmits the same position command to the slave as synchronization information S2. Here, it is presumed that a reception timing on the slave side becomes Ts2 (<Tm2) due to an influence of transfer jitter, etc. In this case, since the slave side may not receive new synchronization information, the position of the drive unit is maintained as before, and a synchronization shift with respect to the master occurs. The slave receives a synchronization signal S2 at a subsequent reception timing Ts3 and updates the position of the drive unit. Therefore, there is a synchronization shift of about one update cycle between the master and the slave.

At time Tm3, the master generates a new position command. The master updates the position of the drive unit thereof in accordance with the new position command, and transmits the same position command to the slave as synchronization information S3. Here, it is presumed that a reception timing on the slave side becomes Ts3 (<Tm3) due to an influence of transfer jitter, etc. In this case, since the slave side may not receive new synchronization information, the position of the drive unit is maintained as before, and a synchronization shift with respect to the master occurs.

At time Tm4, the master generates a new position command. The master updates the position of the drive unit thereof in accordance with the new position command, and transmits the same position command to the slave as synchronization information S4. This time, a reception timing on the slave side is Ts4 (>Tm4), and the slave receives a synchronization signal S4 at Ts4. At Ts4, the slave receives a synchronization signal S3. However, the slave synchronizes according to a newer synchronization signal S4. Such a large position fluctuation may cause vibration.

As described above, in a conventional technology that performs position-based synchronization, when synchronization is attempted by exchanging synchronization information between asynchronous units, a synchronization shift may temporarily occur due to a difference or fluctuation in the update timing of the synchronization information transferred between the master and the slave. The synchronization shift can be eliminated in the long run. However, vibration may occur at that time.

On the other hand, as illustrated in FIG. 2, it is possible to perform synchronization on the basis of speed instead of on the basis of position. In an example of FIG. 2, a speed command V (V1, V2, . . . ) is periodically transferred from the master unit to the slave unit as synchronization information instead of the position command S of FIG. 1. Speed-based synchronization eliminates a need to forcibly adjust the position, and thus it is possible to suppress vibration during synchronous control when compared to position-based synchronization. However, a synchronization error of a position (position shift) may not be eliminated by speed-based synchronization.

Conventionally, there has been a known technology that performs synchronous control based on a speed command in a master-slave mode in a predetermined section, and synchronizes positions by canceling the master-slave mode and inputting a position command in parallel to each unit in another section. For example, JP 10-277791 A is given.

The above-described application is based on the premise of synchronization within the same unit, and is different in object from a technology for improving synchronization accuracy between units that are asynchronous using synchronization information. In addition to a configuration for inputting a speed command to the master unit, this technology requires a configuration of a higher order command device for inputting a position command to each unit in parallel, which complicates a hardware configuration.

### SUMMARY OF THE INVENTION

Therefore, there is a demand for a numerical controller that can accurately synchronize a plurality of units corresponding to asynchronous systems.

A numerical controller corresponding to an aspect of the present disclosure is a numerical controller for performing axis synchronous control between a plurality of units corresponding to asynchronous systems in a master-slave mode, in which speed-based synchronous control is performed in a predetermined section, and position-based synchronous control is performed in another section.

A numerical controller corresponding to an aspect of the present disclosure is a numerical controller of a master unit for synchronizing a slave unit in a master-slave mode, the numerical controller including a synchronization signal transmission unit for transmitting a synchronization signal based on a speed to the slave unit in a predetermined section, and transmitting a synchronization signal based on a position to the slave unit in another section.

A numerical controller corresponding to an aspect of the present disclosure is a numerical controller of a slave unit synchronizing with a master unit in a master-slave mode, the numerical controller including a synchronization signal reception unit for receiving a synchronization signal based on a speed from the master unit in a predetermined section, and receiving a synchronization signal based on a position from the master unit in another section, and a servomotor control unit for driving a servomotor in accordance with the synchronization signal.

According to an aspect of the present disclosure, it is possible to provide a numerical controller capable of accurately synchronizing a plurality of units corresponding to asynchronous systems.

### BRIEF DESCRIPTION OF THE DRAWINGS

FIG. 1 is a diagram for description of position-based synchronous control in a conventional master-slave mode;

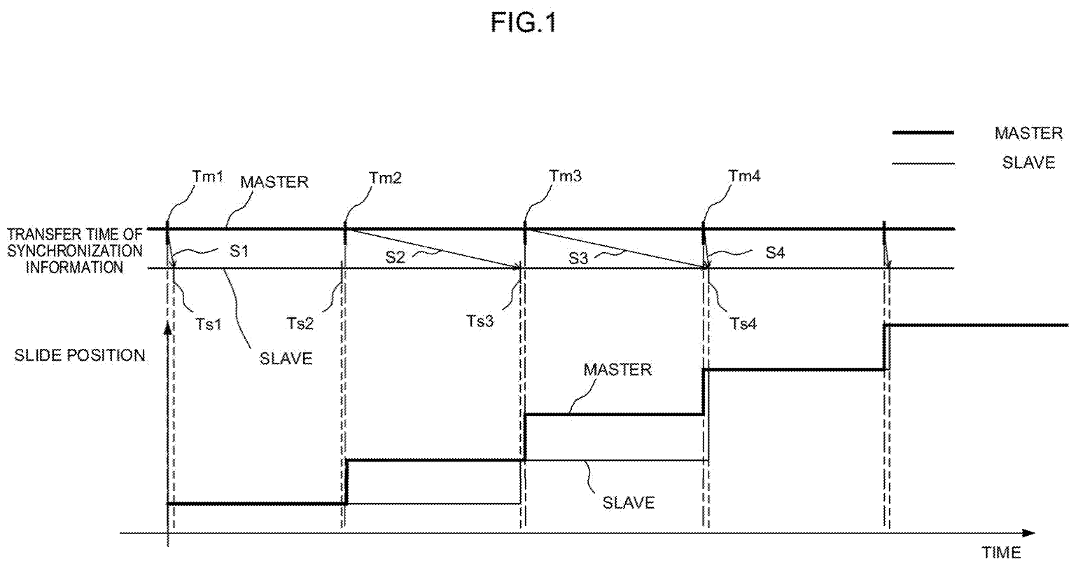

FIG. 2 is a diagram for description of speed-based synchronous control in the conventional master-slave mode;

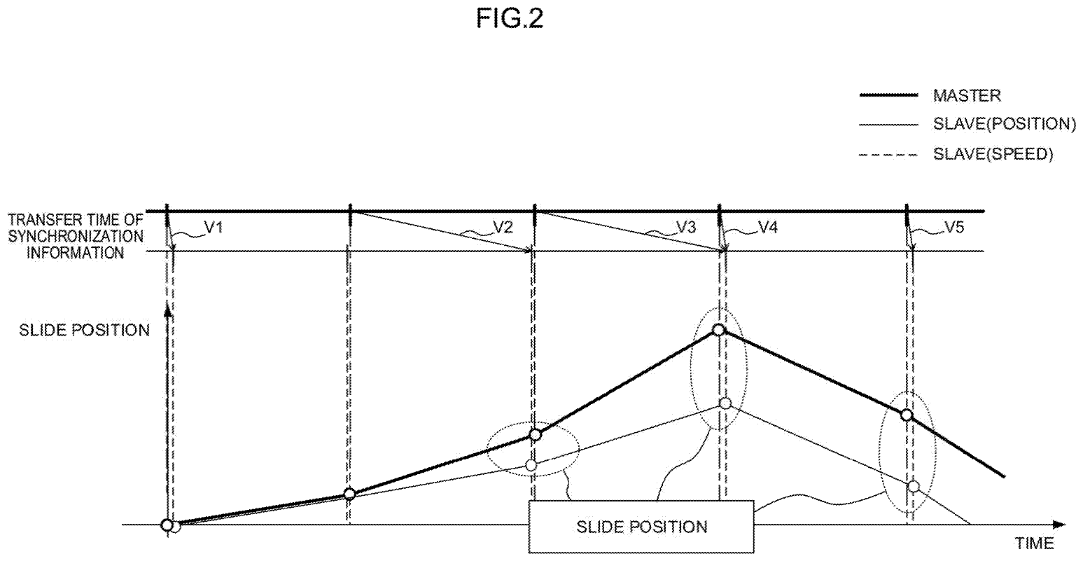

FIG. 3 is a diagram illustrating hardware configurations of a numerical controller M1 and a numerical controller S1;

FIG. 4 is a diagram illustrating configurations of the numerical controller M1 and the numerical controller S1;

FIG. 5 is a diagram illustrating operations of the numerical controller M1 and the numerical controller S1; and

FIG. 6 is a diagram illustrating an embodiment.

### DETAILED DESCRIPTION OF THE PREFERRED EMBODIMENTS

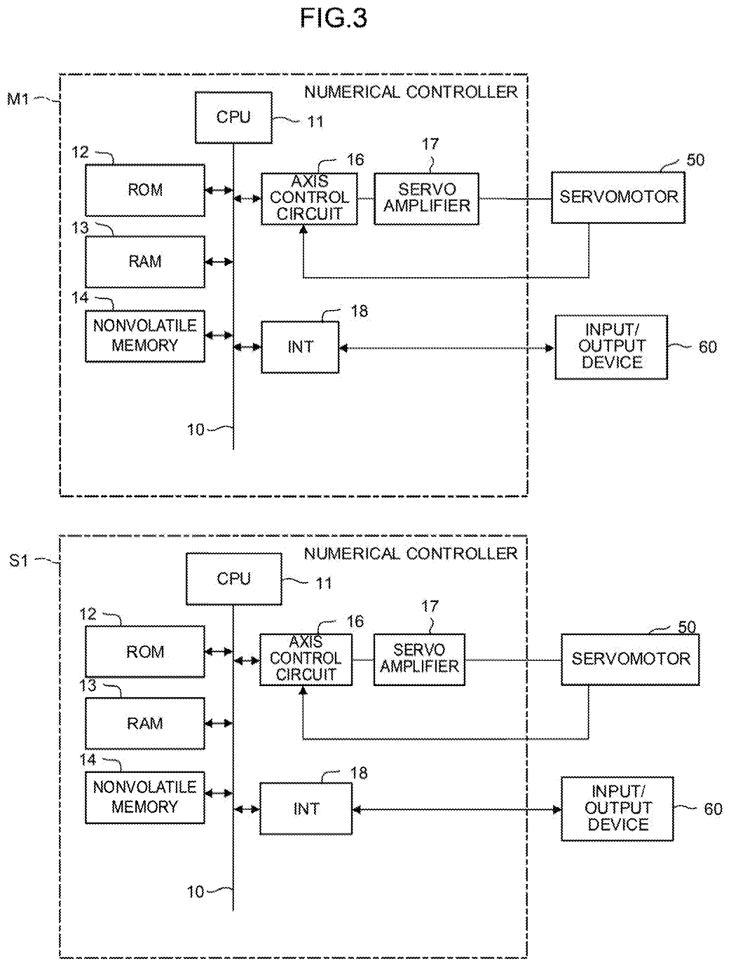

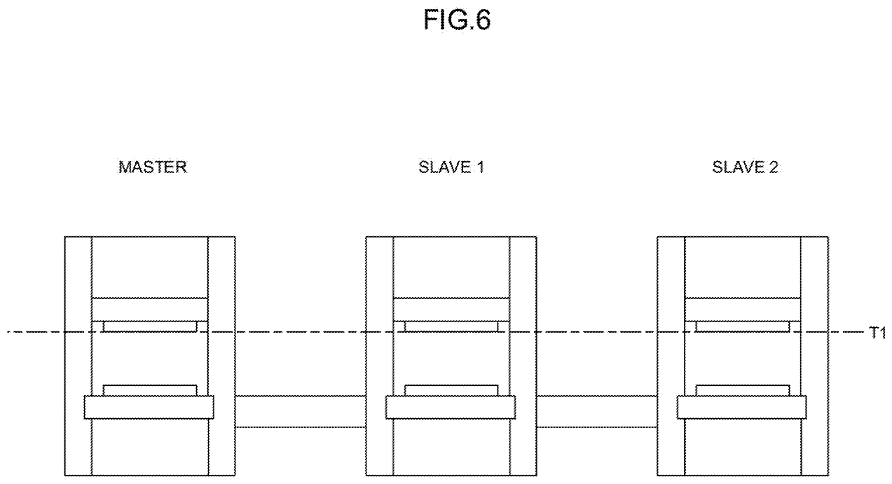

FIG. 3 is a diagram illustrating hardware configurations of main parts of a numerical controller M1 and a numerical controller S1 according to an embodiment. Each of the numerical controller M1 and the numerical controller S1 is a device that controls an industrial machine (hereinafter also simply referred to as a machine. Typically, a press machine, etc. illustrated in FIG. 6 is included). However, the machine controlled by the numerical controller M1 operates as a master unit in a master-slave mode, and the machine controlled by the numerical controller S1 operates as a slave unit in the master-slave mode.

Each of the numerical controller M1 and the numerical controller S1 includes a CPU 11, a ROM 12, a RAM 13, a nonvolatile memory 14, a bus 10, an axis control circuit 16, a servo amplifier 17, and an interface 18. A servomotor 50 and an input/output device 60 of the master unit are connected to the numerical controller M1. A servomotor 50 and an input/output device 60 of the slave unit are connected to the numerical controller S1.

The CPU 11 is a processor that controls the numerical controller M1 or the numerical controller S1 as a whole. The CPU 11 reads a system program stored in the ROM 12 via the bus 10 and controls the entire numerical controller M1 or the entire numerical controller S1 according to the system program.

For example, the ROM 12 stores in advance a system program for executing various controls of the machine.

The RAM 13 temporarily stores temporary calculation data or display data, data or a program input by an operator via the input/output device 60, etc.

The nonvolatile memory 14 is backed up by a battery (not illustrated), for example, and maintains a storage state even when the power of the numerical controller M1 or the numerical controller S1 is cut off. The nonvolatile memory 14 stores data, a program, etc. input from the input/output device 60. The program and data stored in the nonvolatile memory 14 may be loaded in the RAM 13 at the time of execution and use.

The axis control circuit 16 controls an operating axis of the machine. The axis control circuit 16 receives a movement command amount of the axis output by the CPU 11 and outputs a movement command of the operating axis to the servo amplifier 17.

The servo amplifier 17 receives the axis movement command output from axis control circuit 16 and drives servomotor 50 of the master unit.

The servomotor 50 is driven by the servo amplifier 17 to move the operating axis of the machine. In the present embodiment, a main axis is moved by the servomotor 50. The servomotor 50 typically incorporates a position/speed detector. The position/speed detector outputs a position/speed feedback signal, and this signal is fed back to the axis control circuit 16 to perform position/speed feedback control.

In the master-slave mode, the position/speed feedback signal of the master unit is input to the axis control circuit 16 of the numerical controller S1 and used as a position command or a speed command of the servomotor 50 of the slave unit.

The input/output device 60 is a data input/output device having a display, a hardware key, etc., and is typically an MDI or a console panel. The input/output device 60 displays information received from the CPU 11 via the interface 18 on the display. The input/output device 60 passes a command, data, etc. input from the hardware key, etc. to the CPU 11 via the interface 18.

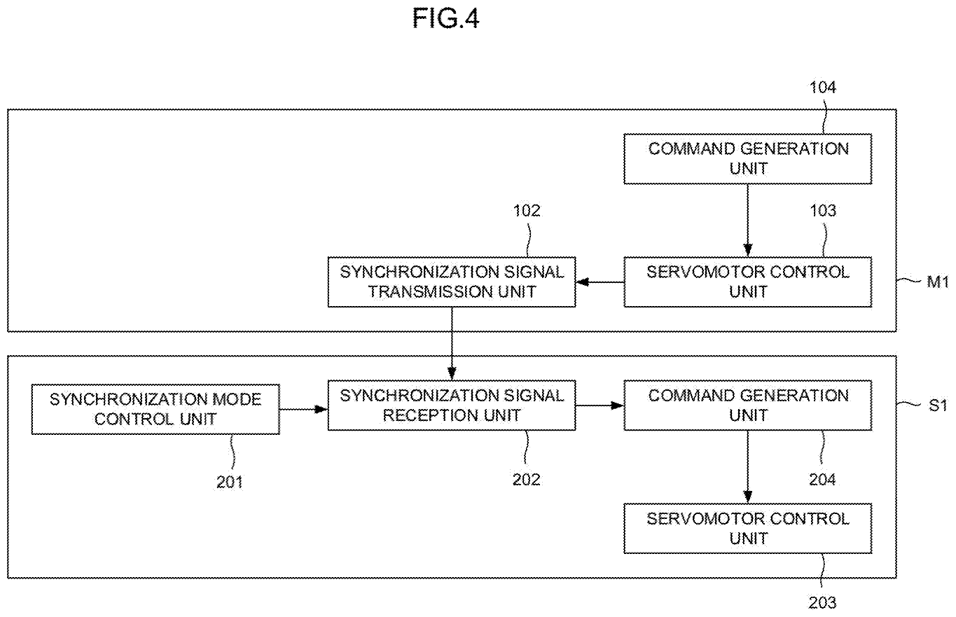

FIG. 4 is a block diagram illustrating a characteristic functional configuration in the master-slave mode of the numerical controller M1 and the numerical controller S1. The numerical controller M1 includes a synchronization signal transmission unit 102, a servomotor control unit 103, and a command generation unit 104. The numerical controller S1 includes a synchronization mode control unit 201, a synchronization signal reception unit 202, a servomotor control unit 203, and a command generation unit 204.

In the case of adopting a synchronous control method in which the slave unit performs speed-based synchronous control (using a speed as a reference value) and position-based synchronous control (using a position as a reference value) while switching between the synchronous controls, the synchronization signal transmission unit 102 transmits, as a synchronization signal necessary for synchronous control, a speed command (speed feedback signal from the servomotor 50 of the master unit) and a speed command (speed feedback signal from the servomotor 50 of the master unit) to the synchronization signal reception unit 202 of the slave unit. The synchronization signal transmitted by the synchronization signal transmission unit 102 may be appropriately changed according to the synchronous control method used in the slave unit. When torque-based synchronous control (using torque as a reference value) is used in the slave unit, a torque command (using pressure as a reference value) may be transmitted. When pressure-based synchronous control is used, a pressure command may be transmitted.

The command generation unit 104 generates a control command (speed command, position command, torque command, pressure command, etc.) according to a command, etc. described in a machining program and transmits the generated control command to the servomotor control unit 103.

The servomotor control unit 103 drives the servomotor 50 of the master unit in accordance with the control command (speed command, position command, torque command, pressure command, etc.) received from the command generation unit 104.

The synchronization mode control unit 201 is a component on the slave unit side that determines a method (speed base, position base, torque base, pressure base, etc.) for synchronizing the slave unit with the master unit. In the present embodiment, the synchronization mode control unit 201 changes the synchronous control method according to an axis position of the slave unit (a Z coordinate in the case of the press machine illustrated in FIG. 6). For example, speed-based synchronous control is performed in a section near a bottom dead center where higher accuracy is required in press machining, and position-based synchronous control is performed in another section to eliminate position shift. Note that the synchronous control (position-based synchronous control) for eliminating the position shift may be performed at any timing except during pressing (section near the bottom dead center). For example, the synchronous control may be performed only during descent of a slide before pressing (outward path), may be performed only during ascent of the slide after pressing (return path), or may be performed both in the forward path and the return path. A threshold (or range) of the axis position at the time of determining the synchronous control method may be given as a fixed value or may be determined by some calculation.

The synchronization mode control unit 201 may determine a switching position or timing of the synchronous control method based on various types of information other than the axis position. For example, the synchronous control method may be switched at a timing when an external signal (an output signal of a shutoff sensor, etc.) is input. Alternatively, the synchronous control method may be switched according to an elapsed time from a predetermined reference time (a time when a machining axis starts moving from a predetermined reference position). A length of the elapsed time may be given as a fixed value or may be determined by some calculation.

The synchronization signal reception unit 202 is a processing unit on the slave unit side that receives a synchronization signal (speed command, position command, torque command, pressure command, etc.) transmitted from the synchronization signal transmission unit 102.

The synchronization signal reception unit 202 outputs the received synchronization signal to the command generation unit 204.

The command generation unit 204 transmits the synchronization signal received from the synchronization signal reception unit 202 to the servomotor control unit 203 as a control command.

The servomotor control unit 203 drives the servomotor 50 of the slave unit in accordance with the control command (speed command, position command, torque command, pressure command, etc.) received from the command generation unit 204.

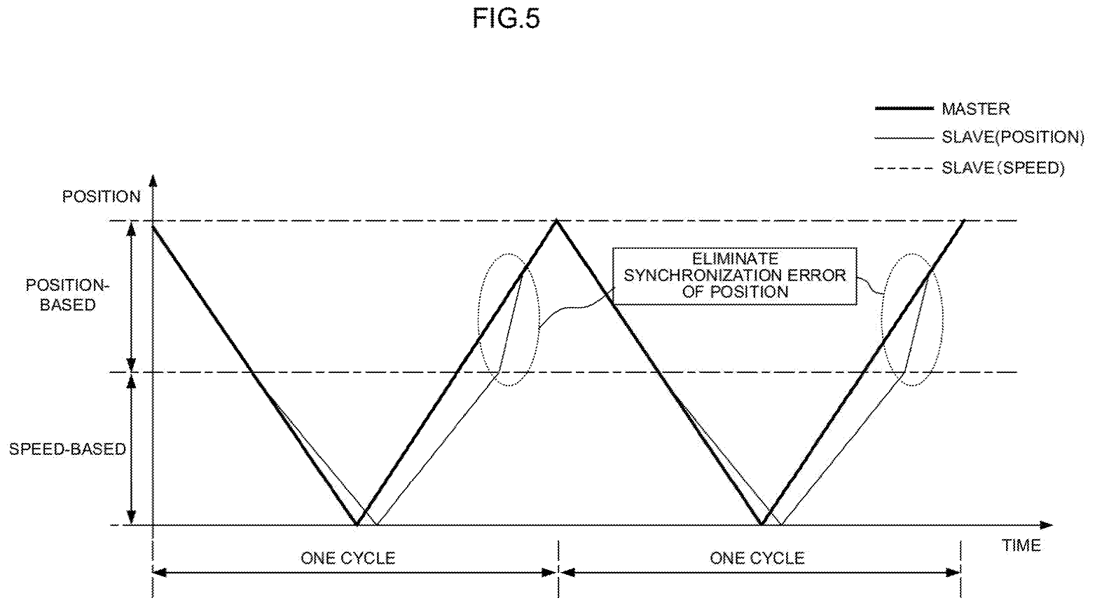

FIG. 5 is a chart illustrating an operation in the master-slave mode by the numerical controller M1 and the numerical controller S1 according to the present embodiment. The numerical controller M1 and the numerical controller S1 perform speed-based synchronous control in a predetermined section before and after the bottom dead center, and perform position-based synchronous control in another section. At a beginning of a first cycle, in a position-based synchronous control section during descent of the slide, a position shift between the master unit and the slave unit is extremely small. In a subsequent speed-based synchronous control section, some position shifts occur. Instead, vibration that may occur when the position shift is eliminated is suppressed. In this section, during execution of pressing, highly accurate press machining can be performed by suppressing vibration. In the latter stage of the first cycle, in the position-based synchronous control section corresponding to ascent of the slide after execution of pressing, the position shift is gradually eliminated and a position synchronization state is recovered. Thereafter, the same control is repeated for each cycle.

According to the present embodiment, in a system in which units are asynchronous, it is possible to achieve both high machining accuracy and suppression of a position shift by switching the synchronous control method according to a purpose. Specifically, in the vicinity of the bottom dead center, etc. of press machining, it is possible to suppress deterioration in machining accuracy due to vibration by performing speed-based synchronous control. In addition, by performing position-based synchronous control while the slide is ascending or descending, accumulation of position synchronization errors can be suppressed.

The present embodiment is not limited to the above-described embodiment, and can be appropriately changed as long as a gist of the present embodiment is not impaired. For example, in the above-described embodiment, synchronous control in a press machine is mainly described as an example. However, an application range of the application is not limited to the press machine, and the application can be applied to an arbitrary industrial machine or carrier device having a shaft driven by a motor via a power transmission mechanism.

In addition, in the above-described embodiment, a case in which one slave unit is present has been described as an example. However, the application is not limited thereto, and can be applied to a case in which a plurality of slave units is present as illustrated in FIG. 6.

1. A numerical controller for performing axis synchronous control between a plurality of units corresponding to asynchronous systems in a master-slave mode,
wherein synchronous control based on a predetermined reference value is performed in a predetermined section, and synchronous control based on another reference value is performed in another section.

2. The numerical controller according to claim 1, wherein speed-based synchronous control is performed in the predetermined section, and position-based synchronous control is performed in another section.

3. A numerical controller of a master unit for synchronizing a slave unit in a master-slave mode, the numerical controller comprising:
a synchronization signal transmission unit for transmitting a plurality of types of reference values used in the slave unit to the slave unit as a synchronization signal.

4. A numerical controller of a slave unit synchronizing with a master unit in a master-slave mode, the numerical controller comprising:
a synchronization signal reception unit for receiving a synchronization signal including a plurality of types of reference values from the master unit; and
a servomotor control unit for driving a servomotor based on a predetermined reference value included in the synchronization signal in a predetermined section and driving the servomotor based on another reference value included in the synchronization signal in another section.
